(19) United States
(12) Patent Application Publication
(10) Pub. No.: US 2009/0001684 A1
(43) Pub. Date: Jan. 1, 2009

(54) BICYCLE SUSPENSION ASSEMBLY

(75) Inventors: Michael McAndrews, Capitola, CA (US); Brian Emery Lampman, Aptos, CA (US)

Correspondence Address: KNOBBE MARTENS OLSON & BEAR LLP, 2040 MAIN STREET, FOURTEENTH FLOOR, IRVINE, CA, 92614, US

(73) Assignee: SPECIALIZED BICYCLE COMPONENTS, INC., Morgan Hill, CA (US)

(21) Appl. No.: 12/134,116

(22) Filed: Jun. 5, 2008

Related U.S. Application Data
(60) Provisional application No. 60/973,912, filed on Sep. 20, 2007.
(60) Provisional application No. 60/947,335, filed on Jun. 29, 2007.

(51) Int. Cl. B62K 25/00

(52) U.S. Cl. 280/276

(57) ABSTRACT

A bicycle suspension assembly may be in the form of a bicycle front suspension fork. The suspension fork may include a pair of telescoping fork legs. In one arrangement, a suspension spring and a damper are provided in only one of the pair of fork legs. The suspension spring assembly may include a negative spring. In one arrangement, the negative spring is a dual stage negative gas spring in which a negative spring gas chamber includes a first chamber section and a second chamber section. The first chamber section and the second chamber section are uncoupled in a first position of the suspension spring and the first chamber section and the second chamber section are coupled in a second position of the suspension spring.

### RELATED APPLICATIONS

This application is related to, and claims priority from, U.S. Provisional Patent Application Nos. 60/973,912, filed Sep. 20, 2007, and 60/947,335, filed Jun. 29, 2007.

### INCORPORATION BY REFERENCE

The entireties of U.S. Provisional Patent Application Nos. 60/973,912, filed Sep. 20, 2007, and 60/947,335, filed Jun. 29, 2007, are hereby incorporated by reference herein and made a part of the present specification.

### BACKGROUND OF THE INVENTION

1. Field of the Invention

The present invention generally relates to suspension assemblies for vehicles. More particularly, the present invention relates to a suspension assembly for a bicycle.

2. Description of the Related Art

Off-road bicycles, or mountain bikes, may be provided with a suspension assembly interposed between one or both of the rear wheel and the front wheel and a frame portion of the bicycle. The front suspension assembly is often in the form of a suspension fork, which includes at least one telescoping fork leg that couples the front wheel to the frame portion for relative motion therebetween. Suspension forks usually incorporate a pair of telescoping fork legs that are arranged with the legs straddling the front wheel. The front suspension fork typically includes both a suspension spring and a damper.

Even though bicycle suspension technology has advanced in recent years, bicycle riders still demand increases in performance and adjustment features for bicycle suspension systems, while maintaining, or even reducing, the overall weight of the system. Providing sufficient strength, performance and adjustment features within the space available for a front suspension fork, due at least in part to restrictions on the overall height of the bicycle, is especially challenging.

### SUMMARY OF THE INVENTION

In one embodiment, the present bicycle suspension assembly is a bicycle front fork that provides desirable performance characteristics and adjustment features, while remaining competitively lightweight. In one arrangement, the bicycle suspension fork includes a pair of telescoping fork legs joined to a steer tube by a fork crown. Both a suspension spring and a damper are provided in only one of the pair of fork legs. The damper may include a floating piston that separates a damping fluid chamber from a gas chamber. In one arrangement, a valve permits communication with the gas chamber and the valve is at least partially integrated into a damping adjustment mechanism of the damper. The suspension spring assembly may include a negative spring. In one arrangement, the negative spring is a dual stage negative gas spring in which a negative spring gas chamber includes a first end and a second end. The second end of the negative spring gas chamber is defined by a first seal in a first position of the suspension spring and is defined by a second seal in a second position of the suspension spring.

A preferred embodiment is a bicycle suspension fork including a first fork leg, comprising an upper fork tube and a lower fork tube, and a second fork leg, comprising an upper fork tube and a lower fork tube. A suspension spring that provides substantially all of a spring force of the suspension fork is positioned within the first fork leg and not within the second fork leg. The suspension spring includes a gas spring chamber and a gas spring piston. The gas spring piston is movable to vary a volume of the gas spring chamber. A damper that provides substantially all of a damping force of the suspension fork is positioned within the first fork leg and not within the second fork leg. The damper includes a damping chamber, a piston rod and a damping piston supported on an end portion of the piston rod. The piston rod and the damping piston are movable within said damping chamber. The damping piston moves relative to the gas spring piston when the upper fork tube of the first fork leg moves relative to the lower fork tube of the first fork leg.

A preferred embodiment is a bicycle suspension fork including a first fork leg having a first fork tube telescopically engaged with a second fork tube and a second fork leg having a first fork tube telescopically engaged with a second fork tube. A suspension spring that provides substantially all of a spring force of the suspension fork is positioned within the first fork leg and not within the second fork leg. The suspension spring includes a gas spring chamber and a gas spring piston. The gas spring piston is movable to vary a volume of the gas spring chamber. A damper that provides substantially all of a damping force of the suspension fork is positioned within the first fork leg and not within the second fork leg. The damper includes a damping chamber, a piston rod and a damping piston supported on an end portion of the piston rod. The piston rod and the damping piston are movable within the damping chamber. The damping piston is coupled for movement with the first fork tube of the first fork leg and the gas spring piston is coupled for movement with the second fork tube of the first fork leg.

A preferred embodiment is a bicycle suspension fork including a first fork leg, comprising an upper fork tube and a lower fork tube, and a second fork leg, comprising an upper fork tube and a lower fork tube. A suspension spring that provides substantially all of a spring force of the suspension fork is positioned within the first fork leg and not within the second fork leg. The suspension spring includes a gas spring chamber and a gas spring piston. The gas spring piston is movable to vary a volume of the gas spring chamber. A damper that provides substantially all of a damping force of the suspension fork is positioned within the first fork leg and not within the second fork leg. The damper includes a damping chamber, a piston rod and a damping piston supported on an end portion of the piston rod. The piston rod and the damping piston are movable within the damping chamber. A reservoir chamber receives fluid displaced from the damping chamber. The damping chamber is separated from the reservoir chamber by one or more valves.

A preferred embodiment is a suspension assembly for a bicycle including a first portion and a second portion. A first piston is carried by the second portion. The first piston and the first portion cooperate to define a positive air spring chamber that produces a force tending to extend the first portion relative to the second portion. A negative air spring produces a force tending to compress the first portion and the second portion. The negative air spring includes a first chamber and a second chamber. The suspension assembly includes at least a first seal arrangement. The first seal arrangement separates the first chamber from the second chamber in a first relative position of the first portion and the second portion. The first seal arrangement allows communication between the first chamber and the second chamber in a second relative position of the first portion and the second portion.

A preferred embodiment is a suspension assembly for a bicycle including a first portion comprising a piston rod carrying a damping piston and a second portion defining at least one fluid chamber filled with a damping fluid. The damping piston is movable within the at least one fluid chamber. The piston rod occupies a varying volume of the at least one fluid chamber when the damping piston moves between a first position and a second position within the at least one fluid chamber. A damping adjustment mechanism extends from external the suspension assembly to a damping valve. The damping adjustment mechanism configured to permit external adjustment of the damping valve. A gas chamber is separated from the at least one fluid chamber by a partition. The partition is movable to vary a volume of the gas chamber to compensate for variation in a volume of the at least one fluid chamber that is occupied by the piston rod. A fill valve is configured to permit a gas to be introduced into the gas chamber through a fill passage. The fill passage is at least partially defined by the damping adjustment mechanism.

A preferred embodiment involves a method of adjusting a mass of fluid within a suspension assembly that includes providing a tube that forms a portion of the suspension assembly. A first piston is inserted into an open end of a tube to create a seal between the first piston and the tube and to define a first end of a fluid chamber. The first piston is advanced within the tube until the first end of the fluid chamber is in a first position relative to the open end of the tube. A fluid is allowed to enter the fluid chamber. A second piston is inserted into the tube to create a seal between the second piston and the tube and to define a second end of the fluid chamber. The first position of the first piston is selected such that the insertion of the second piston traps a desired mass of the fluid within the fluid chamber.

A preferred embodiment is a bicycle suspension fork including a first fork leg having an upper fork tube and a lower fork tube and a second fork leg having an upper fork tube and a lower fork tube. A suspension spring that provides substantially all of a spring force of the suspension fork is positioned within the first fork leg and not within the second fork leg. A damper that provides substantially all of a damping force of the suspension fork is positioned within the first fork leg and not within the second fork leg. A crown couples the upper fork tube of the first fork leg with the upper fork tube of the second fork leg includes a wall portion that extends completely over an upper end of the upper fork tube of the second fork leg.

### BRIEF DESCRIPTION OF THE DRAWINGS

These and other features, aspects and advantages of the present invention are described below with drawings of preferred embodiments, which are intended to illustrate but not to limit the present invention. The drawings contain twelve (12) figures.

FIG. 1 is a side elevation view of a bicycle incorporating a front suspension assembly having certain features, aspects, and advantages of the present invention.

FIG. 2 is a front view of the front suspension assembly of the bicycle of FIG. 1. In FIG. 2, the front suspension assembly is separated from the bicycle.

FIG. 3 is a cross-sectional view of the pair of fork legs of the front suspension assembly of FIG. 2. A suspension spring and a damper are provided in only one of the fork legs.

FIG. 4 is an enlarged, cross-sectional view of a portion of the fork leg that incorporates the suspension spring and damper. The portion of the fork leg illustrated in FIG. 4 is identified by the circle labeled 4 in FIG. 3.

FIG. 5 is an enlarged, cross-sectional view of an upper end of the fork leg incorporating the suspension spring and damper. The portion of the fork leg illustrated in FIG. 5 is identified by the circle labeled 5 in FIG. 3.

FIG. 6 is an enlarged, cross-sectional view of a lower portion of the fork leg incorporating the suspension spring and damper. The portion of the fork leg illustrated in FIG. 6 is identified by the circle labeled 6 in FIG. 3

FIG. 7 is a cross-sectional view of the fork leg incorporating the suspension spring and damper taken along line 7-7 of FIG. 6.

FIG. 8 is a cross-sectional view of the fork leg including the suspension spring and damper taken along the line 8-8 of FIG. 6.

FIG. 9 is an enlarged, cross-sectional view of a portion of the lower end of the fork leg of FIG. 6 showing a damping adjustment mechanism with an integrated valve for permitting gas to be introduced to the gas chamber of the damper.

FIG. 10 is a cross-sectional view of the fork leg containing the suspension spring and damper taken along line 10-10 of FIG. 9.

FIG. 11 is a cross-sectional view of the fork leg containing the suspension spring and damper taken along line 11-11 of FIG. 9.

FIGS. 12a and 12b illustrate a negative spring arrangement of the suspension spring of the bicycle fork of FIG. 2. FIG. 12a illustrates the negative spring in a first position of the suspension spring in which one end of the negative spring is defined by a first seal. FIG. 12b illustrates the negative spring in a second position of the suspension spring in which the one end of the negative spring is defined by a second seal, instead of said first seal.

### DETAILED DESCRIPTION OF THE PREFERRED EMBODIMENTS

The present suspension assembly is described herein in the form of a front suspension fork for a bicycle 20. As used herein, the term “fork” is used in its ordinary meaning and includes various forms of a front suspension assembly for a vehicle and, in particular, for a bicycle. Thus, the term “fork” encompasses a suspension assembly having one or more legs or struts. In addition, linkage-type front suspension assemblies are also intended to fall within the definition of a “fork.” Moreover, certain features, aspects and advantages of the present suspension assembly may be utilized in the suspension systems of other vehicles, as well. For example, certain features, aspects and advantages of the present suspension assembly may be utilized in other two-wheeled vehicles, such as motorcycles, for example. In addition, certain features, aspects and advantages of the present suspension assembly may be utilized in vehicles having another number of wheels, (e.g., an automobile) or having no wheels (e.g., a snowmobile). Thus, although the present suspension assembly is described in the context of a front suspension fork for a bicycle, the present invention is not limited to any particular structure or function disclosed herein. Certain features, aspects and advantages of the present suspension assembly may find use in non-vehicular applications as well.

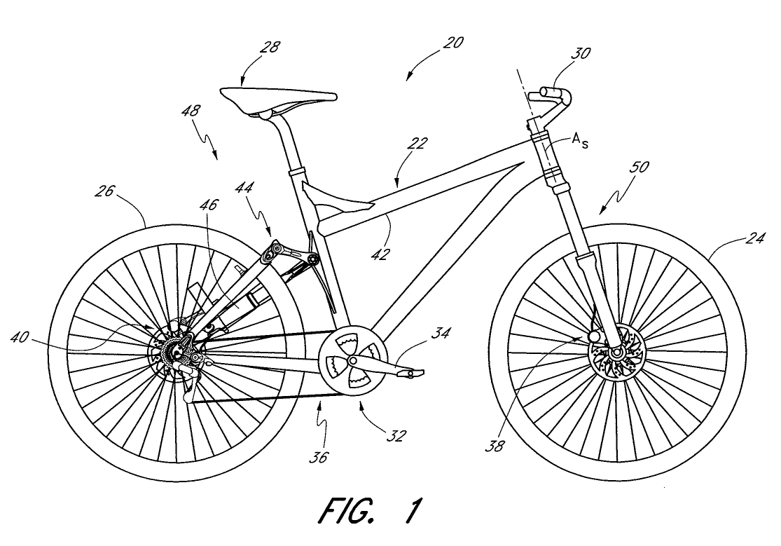

FIG. 1 illustrates a bicycle, and more particularly, an off-road bicycle or mountain bike 20. To aid in the description of the mountain bike 20 and the present suspension assembly, certain directional or relative terms may be used herein. The term “longitudinal” refers to a direction, length or a location between the front and rear of the bicycle 20. The term “lateral” refers to a direction, length or location between the sides of the bicycle 20. Heights may be described as relative distances from a surface upon which the bicycle 20 is operated in a normal manner. Thus, the terms “above” or “below” generally apply to the suspension assembly as assembled to a bicycle, and the being bicycle oriented as it would be normally ridden, or as the suspension assembly is depicted in any of the relevant figures. Front, rear, left, and right directions generally refer to those directions from the perspective of a rider normally seated on the bicycle 20.

With reference to FIG. 1, the mountain bike 20 includes a frame assembly 22, a front wheel 24 and rear wheel 26. The frame assembly 22 supports a seat assembly 28 at a location spaced rearward from a handlebar assembly 30. The handlebar assembly 30 is rotatably supported by the frame assembly 22 and is coupled to the front wheel 24 such that rotation of the handlebar 30 results in rotation of the front wheel 24 about a steering axis A_{S} of the mountain bike 20.

The mountain bike 20 also includes a drive train 32 that is configured to allow a rider of the mountain bike 20 to supply power to one or both of the wheels 24, 26. In the illustrated arrangement, the drive train 32 includes a pedal crank 34 that is coupled to the rear wheel 26 by a multispeed chain drive transmission 36. The multispeed chain drive transmission 36 may include one or more gears, or chain rings, coupled to the pedal crank 34 and one or more gears, or sprockets, coupled to the rear wheel 26. The chain rings and sprockets are coupled by an endless drive chain that is capable of transmitting torque from the pedal crank 34 to the rear wheel 26. One or more shifting mechanisms, such as a derailleur, may be provided to shift the chain between the chain rings or sprockets. The shifting mechanism may be controlled by rider controls mounted on the handlebar assembly 30.

The mountain bike 20 includes front and rear brake assemblies 38, 40 associated with the front and rear wheels 24, 26, respectively. The brake assemblies 38, 40 may be controllable by a rider of the mountain bike 20, typically via hand controls provided on the handlebar 30. The brake assemblies 38, 40 are capable of providing a force that resists motion of the respective wheel 24, 26 to slow or stop the mountain bike 20. Although the illustrated brake assemblies 38, 40 are disc brakes, other suitable types of brakes assemblies, such as rim brakes, for example, may also be used.

Preferably, the rear wheel 26 is supported for movement relative to at least a portion of the frame assembly 22. More particularly, the frame assembly 22 includes a mainframe portion 42 and a subframe portion, or wheel support portion 44. The subframe portion 44 moveably supports the rear wheel 26 relative to the mainframe portion 42 of the frame assembly 22. A suspension element, such as a shock absorber 46, is operably positioned between the mainframe 42 and the subframe 44 to influence movement of the subframe 44, and the rear wheel 26, relative to the mainframe 42. Together, the subframe 44 and shock absorber 46 form a rear suspension system 48 of the mountain bike 20. In the illustrated arrangement, the subframe 44 is a multi-linkage arrangement that includes a plurality of interconnected linkage members. However, as will be appreciated by one of skill in the art, a multitude of possibilities for the exact configuration of the mainframe 42 and subframe 44 are possible. Moreover, in some arrangements, the mountain bike 20 may be of a rigid frame design, or hardtail, in which no rear suspension assembly 48 is provided. The mainframe 42 and subframe 44 may be of any suitable shape and may be constructed of any suitable material or combination of materials, as will be appreciated by one of skill in the art.

The mountain bike 20 also incorporates a front suspension assembly 50 that movably supports the front wheel 24 relative to the mainframe 42 of the frame assembly 22. The front suspension assembly 50 as illustrated herein is a suspension fork 50 that is supported at its upper end by the mainframe 42 for rotation relative to the frame assembly 22 of the mountain bike 20. The suspension fork 50 rotatably supports the front wheel 24 at its lower end. The handlebar 30 is coupled to the suspension fork 50 such that rotation of the handlebar 30 causes rotation of the front suspension fork 50, and thus the front wheel 24, about the steering axis A_{S}.

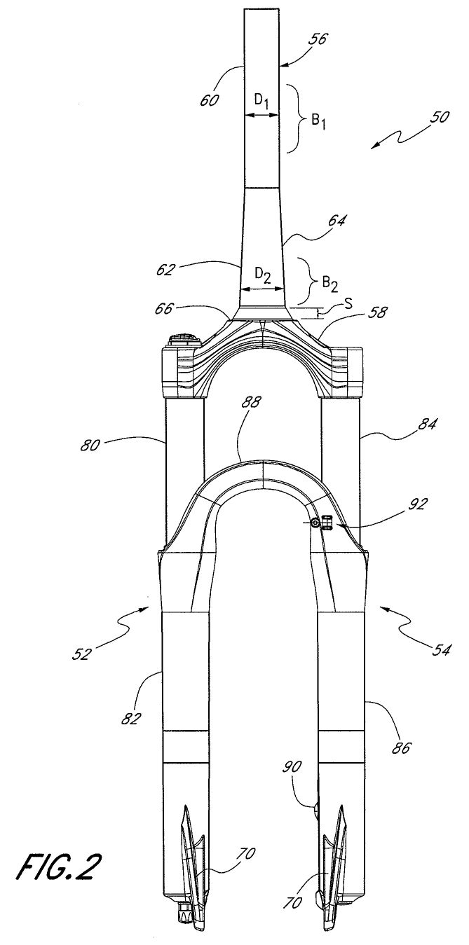

With reference to FIG. 2, the suspension fork 50 is shown separated from the remainder of the mountain bike 20. In the illustrated arrangement, the suspension fork 50 includes a first fork leg 52 and a second fork leg 54 that straddle the front wheel 24 of the mountain bike 20. The upper ends of the fork legs 52, 54 are coupled to a steer tube, or steerer 56. The steer tube 56 is received within a head tube of the mainframe 42 of the bicycle frame assembly 22. The steer tube 56 is coupled to the fork legs 52, 54 by a crown 58. In the illustrated arrangement, the crown 58 is an arch-shaped member. End portions of the arch-shaped crown 58 surround an upper end of a respective one of the fork legs 52, 54. The steer tube 56 extends upward from a center of the arch-shaped crown 58 and, preferably, is integrally formed with the crown 58. That is, preferably the steer tube 56 and crown 58 are created as a single component. In one arrangement, the steer tube 56 and crown 58 are formed by molding a composite material, such as a carbon fiber and resin composite. However, in other arrangements, the steer tube 56 and crown 58 may be created by two or more pieces secured to one another.

In the illustrated arrangement, the steer tube 56 has an upper end portion 60 that defines a first diameter D1 and a lower end portion 62 that defines a second diameter D2. Preferably, the diameter D2 is larger than the diameter D1. In one preferred arrangement, the diameter D1 is approximately 1⅛ inches and the diameter D2 is approximately 1½ inches. However, other suitable sizes for the steer tube 56 may also be used. A tapered transition portion 64 extends between the upper portion 60 and the lower portion 62.

As noted above, the steer tube 56 is rotatably supported by the frame assembly 22 of the mountain bike 20. In particular, the steer tube 56 is typically supported by a pair of bearings spaced from one another along an axis of the steer tube 56. Accordingly, the steer tube 56 defines a first region B1 that is configured to supported by an upper bearing and a second region B2 that is configured to be supported by a second bearing. The region B2 is spaced below the region B1 and preferably is located near a lower end of the steer tube 56. The steer tube 56 preferably is of the diameter D1 in the region B1 and is of the diameter D2 in the region B2.

A relatively flat, narrow annular ledge 66 is defined by a relatively abrupt transition (at least as compared to the tapered transition 64) between the steer tube 56 and the crown 58. The ledge 66 is configured to be positioned adjacent a lower end of the head tube of the bicycle frame assembly 22 when the suspension fork 50 is assembled to the mountain bike 20 to provide a neat appearance to the transition between the suspension fork 50 and frame assembly 22. Preferably, the bearing region B2 is spaced above the ledge 66 by a distance S. In one arrangement, the distance S is about one-half inch. However, the distance S may be varied to suit a particular frame assembly 22 or desired functional or aesthetic characteristics of the suspension fork 50 and/or bicycle frame assembly 22.

As described above, a lower end of the suspension fork 50 is configured to carry the front wheel 24 of the mountain bike 20. In the illustrated arrangement, each fork leg 52, 54 includes a wheel mount 70. The wheel mounts 70 cooperate with one another to support the front wheel 24. The wheel mounts 70 are often referred to as dropouts because the mounts 70 often include a generally vertical recess that is open at its lower end. The recess permits an axle of the front wheel 24 to “drop out” of the lower end of the recess when the wheel retention mechanism is loosened. However, the wheel mounts 70 may be of any suitable construction to support and axle of the front wheel 24, including the through-axle type mounting arrangement in which the wheel mounts 70 completely surround the axle of the front wheel 24. Other suitable arrangements may also be used.

The fork leg 52 includes an upper fork leg portion or stanchion tube 80 (“upper fork leg or tube”) and a lower fork leg portion 82 (“lower fork leg or tube”). The fork legs 80, 82 are telescopically engaged with one another such that an overall length of the fork leg 52 may vary. Similarly, the fork leg 54 includes an upper fork leg 84 and a lower fork leg 86 telescopically engaged with one another. The crown 58 interconnects the upper ends of the upper fork leg 80 and upper fork leg 84. Similarly, upper ends of the lower fork legs 82 and 86 are interconnected by an arch 88. The arch 88 preferably is integrally formed with the legs 82 and 86. In one arrangement, the legs 82 and 86, the arch 88 and the wheel supports 70 are cast as a single piece. However, other suitable arrangements are possible as well. The crown 58 and the arch 88 resist twisting of the upper fork legs 80, 84 and lower fork legs 82, 86, respectively.

The fork 50 preferably also includes a brake mount 90 that is configured to support the front brake 38. The brake mount 90 may be of any suitable arrangement to support a front brake assembly relative to the front wheel 24. In addition, the fork 50 may also include a brake line mount 92 that is configured to receive and facilitate the retention of a brake line of the front brake 38. The brake line mount 92 assists in maintaining the brake line away from contact with the front wheel 24 throughout the suspension movement of the fork 50.

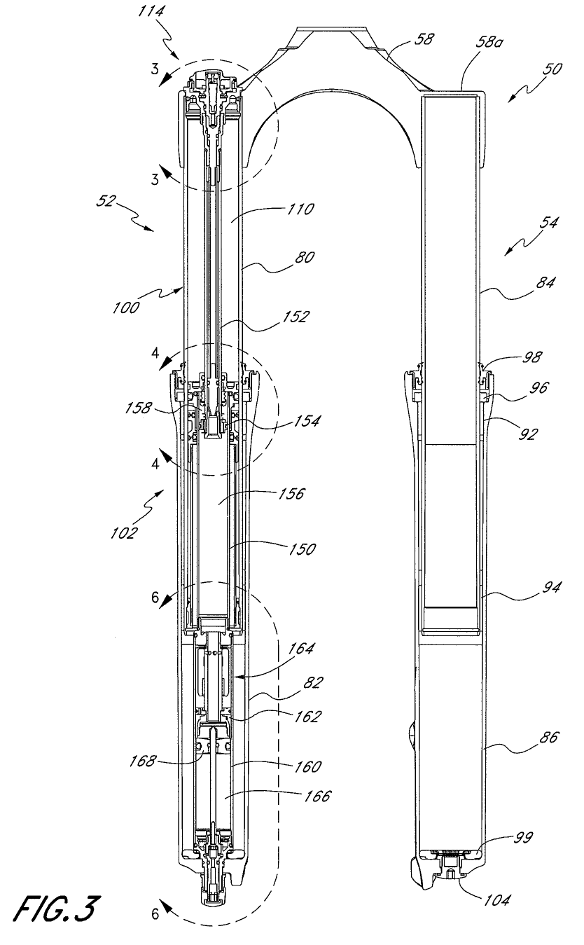

FIG. 3 is a cross-sectional view that illustrates certain internal components of the suspension fork 50. Each of the fork legs 52, 54 includes an upper bushing 92 and a lower bushing 94 interposed between the upper fork leg 80, 84 and the lower fork leg 82, 86. Preferably, the bushings 92, 94 are supported by the lower fork legs 82, 86 and provide a surface on which the upper fork legs 80, 84 slide relative to the lower fork legs 82, 86. A seal 96 and a wiper 98 are positioned at an upper end of the lower fork legs 82, 86. The seal 96 preferably creates a fluid tight seal between the upper fork legs 80, 84 and the lower fork legs 82, 86 to prevent any fluid that may be within the interior of the fork legs 52, 54 from escaping. The wiper 98 inhibits foreign material, such as dirt, or water, from entering the fork leg 52, 54 upon movement of the upper fork legs 80, 84 into the lower fork legs 82, 86. Bottom-out bumpers 99 are provided at the bottom of each of the lower fork legs 82, 86. The bottom-out bumpers 99 act as a cushion to prevent direct contact between lower ends of the upper fork tubes 80, 84 with lower ends of the lower fork legs 82, 86 upon full compression of the suspension fork 50.

Preferably, the suspension fork 50 includes a suspension spring 100 and a damper 102. In one preferred arrangement, both the suspension spring 100 and the damper 102 are positioned within only one of the legs 52, 54 of the suspension fork 50. Furthermore, the suspension spring 100 provides substantially all of a spring force of the fork 50 and the damper 102 provides substantially all of a damping force of the fork 50. In the illustrated arrangement, the suspension spring 100 and the damper 102 are positioned within the leg 52 that is located on the right side of the front wheel 24 (the left side of FIG. 3). Preferably, the suspension spring 100 and damper 102 are contained within a space defined by the upper tube 80 and lower tube 82 of the right fork leg 52. However, in other arrangements, it is possible that portions of the suspension spring 100 and/or damper 102 are located within additional structures of the fork 50, such as a remote reservoir tube, for example. Thus, the term “positioned within” when referring to the fork leg 52 or 54 includes possible additional structural elements besides the upper tubes 80 or 84 and the lower tubes 82 or 86.

Desirably, the other fork leg 54 is substantially empty, with the possible exception of a relatively small amount of lubricating fluid to lubricate the bushings 92, 94 and seal 96. The fork leg 54 includes an end cap 104 that closes an access opening to the interior of the fork leg 54. The cap 104 may be removed to permit lubricating fluid to be introduced to, or removed from, the interior of the fork leg 54. Because it is not necessary to install components into, or remove components from, an interior of the fork leg 54, the crown 58 can include a wall portion 58a that covers the upper end of the upper tube 84 of the fork leg 54. Preferably, the wall portion 58a is unitary at least with a portion of the crown 58 that surrounds the upper end portion of the upper tube 84 and closes an open, upper end of the upper tube 84. As described above, the entire crown 58 (and, possibly, the steerer 56) may be formed by a single piece.

### Preferred Embodiments of a Suspension Spring

The suspension spring 100 is described below with reference to FIGS. 3-6, 12a and 12b. Preferably, the suspension spring 100 includes a positive spring and a negative spring. The positive spring acts to resist compressive movement (i.e., compression) of the suspension fork 50, in which the overall length of the fork legs 52, 54 is reduced. The negative spring acts in opposition to the positive spring. Thus, the negative spring provides a force tending to compress the suspension fork 50 or resist extension movement (i.e., rebound) of the suspension fork 50, in which the overall length of the fork legs 52, 54 is increased.

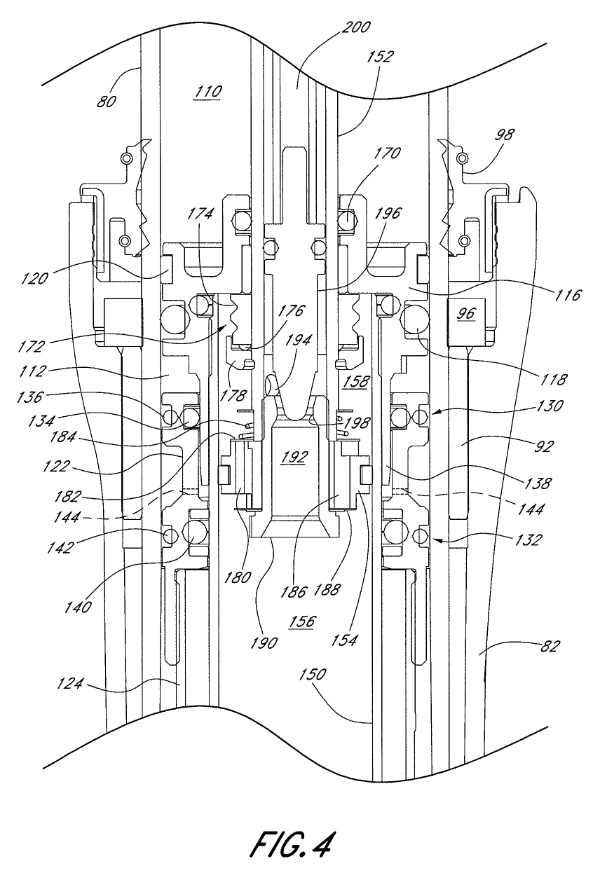

In the illustrated arrangement, the positive spring is a gas spring that includes a positive air spring chamber 110. Desirably, the negative spring is also a gas spring that includes a negative air spring chamber 112 (FIG. 4). For convenience, the positive air chamber 110 and the negative air chamber 112 utilize air as the gas. However, in other arrangements, other types of suitable gases may be used instead.

The positive air spring 110 is defined between a top cap assembly 114 and a main piston 116. The top cap assembly 114 closes an upper end of the fork leg 52. The main piston 116 is positioned within the interior of the fork leg 52 and is movable along with the lower fork leg 82. Thus, upward movement of the lower fork leg 82 results in upward movement of the piston 116 relative to the top cap 114. Upward movement of the piston 116 reduces the volume of the positive air chamber 110. A reduction in the volume of the positive air spring chamber 110 results in an increase in a force produced by the spring in accordance with a force-displacement curve particular to the type of gas provided in the positive air spring chamber 110. The main spring piston 116 carries a first seal member 118 that preferably creates a substantially airtight seal between the piston 116 and an inner surface of the upper fork leg 80. A bushing 120 is also carried by the main piston 116. The bushing 120 is interposed between the piston 116 and the inner surface of the upper fork leg 80. The bushing 120 enhances the ability of the piston 116 to slide within to the upper fork leg 80 and may also provide some sealing function. The main spring piston 116 also includes one or more additional seals that are described in greater detail later.

The negative spring chamber 112 is defined between the positive spring piston 116 and a negative spring piston 122, which is movable with the upper fork leg 80. Thus, when the upper fork leg 80 moves downward relative to the lower fork leg 82 (i.e., compression of the suspension fork 50), the negative spring piston 122 moves downward, away from the main piston 116, to increase the volume of the negative air spring chamber 112. In other words, the negative spring air chamber 112 tends to move the negative spring piston 122 away from the main piston 116 and, thus, compress the suspension fork 50. As is understood by those of skill in the art, the negative spring assists in initial compression of the suspension fork 50 by at least partially counteracting inherent friction of the suspension spring. The inherent friction may be caused by the various seals that contact the movable portions of the suspension spring 100, for example, or other components of the suspension fork 50.

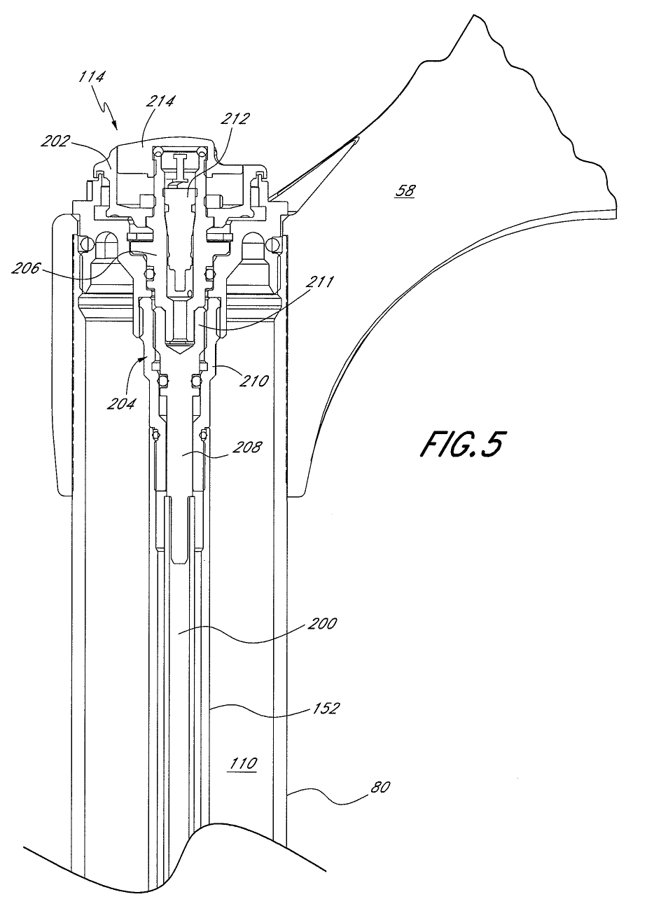

With reference to FIGS. 4 and 6, the negative spring piston 122 is coupled to an upper end of a support tube 124. A lower end of the support tube 124 is coupled to a lower end of the upper fork leg 80 by an annular support member 126, which occupies the radial space between the support tube 124 and the upper fork leg 80. The annular support member 126 includes female threads that mate with male threads of a lower end of the support tube 124. The support tube 124 and annular support member 126 may be retained within the upper fork leg 80 by any suitable mechanism, such as the clip and groove arrangement 128 illustrated in FIG. 6. Such an arrangement facilitates assembly of the negative spring. The support tube 124 is a convenient mechanism for positioning and retaining the negative spring piston 122 at the illustrated location spaced a significant distance from a lower end of the upper fork leg 80. However, other suitable mechanisms or arrangements for positioning and/or retaining the negative spring piston 122 at a desired position within the upper fork leg 80. In addition, the negative spring piston 122 preferably is capable of axial adjustment relative to the support tube 124 and, thus, the positive spring piston 116 (such as through the illustrated threaded connection) such that the volume of the negative spring chamber 112 can be adjusted. In an alternative arrangement, the position of the support tube 124 relative to the positive spring piston 116 or the upper fork leg 80 may be adjustable to adjust a position of the negative spring piston 122. Moreover, other suitable adjustment mechanisms for the negative spring piston 122 may also be used.

Furthermore, the illustrated negative spring arrangement permits the mass of the air trapped within the negative spring to be selected during assembly of the suspension fork 50. In particular, when the damper tube 150 is positioned within upper fork leg 80, the seal member 118 establishes the upper end of the negative spring chamber 112. The lower end of the negative spring chamber 112 is established when the negative spring piston 122 is inserted into the fork leg 80 and a lower seal arrangement 132 (or an upper seal arrangement 130) establishes a seal with both the upper fork leg 80 and the damper tube 150 (or the flange 138). The specific position of the positive spring piston 116 (and, thus, the seal member 118) within the fork leg 80 at the time that the negative spring piston 122 is inserted into the fork leg 80 determines the mass of the air that is trapped within the negative spring chamber 112. Thus, altering a position of the damper tube 150 and seal element 118 (the first or upper end of the negative spring chamber 112) within the upper fork leg 80 prior to inserting the negative spring piston 122 into the upper fork leg 80 (establishing the second end or lower end of the negative spring chamber 112), allows the mass of the air trapped within the negative spring chamber 112 to be altered. The trapped mass of the air affects the magnitude of the pressure of the negative spring chamber 112 at any relative position of the upper fork leg 80 and lower fork leg 82. In other words, varying the mass of the trapped air shifts the force-displacement curve of the negative spring. Trapping a greater mass of air in the negative spring chamber 112 will result in a higher force for a given displacement than when a lesser mass of air is trapped in the negative spring chamber 112. Advantageously, such an arrangement permits the pressure curve of the negative spring to be altered without having to provide an externally-accessible air valve that would permit air to be added or removed from the negative spring chamber 112, which would add complexity and cost to the suspension fork 50.

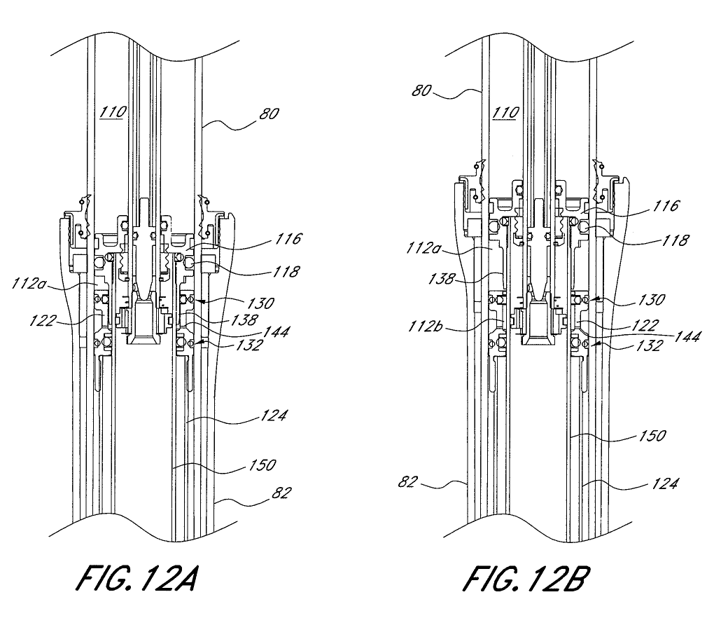

Preferably, the negative spring is a dual stage arrangement. In the illustrated arrangement, in one position of the fork, a lower end of the negative spring is defined by a first seal and, in another position of the fork, the lower end of the negative spring is defined by a second seal. Preferably, the negative spring piston 122 includes the first seal arrangement 130 and the second seal arrangement 132, introduced above. The first seal arrangement 130 is positioned above the second seal arrangement 132. The first seal arrangement 130 includes an inner seal member 134 and an outer seal member 136. The inner seal member 134 creates an at least substantially fluid-tight seal between the negative spring piston 122 and a downwardly-extending flange portion 138 of the main piston 116 when the negative spring piston 122 is positioned such that the inner seal member 134 contacts the flange 138. The outer seal member 136 creates an at least substantially fluid-tight seal between the negative spring piston 122 and an inner surface of the upper fork leg 80. When the inner seal member 134 creates a seal with the flange 138 of the main piston, the negative spring is defined by a section 112a (FIG. 12A) of the negative spring chamber 112 between the seal member 118 and the first seal arrangement 130. The section 112a is also referred to herein as the first chamber 112a of the negative spring. The seal members 134, 136 may be of any suitable construction to permit a seal to be created and maintained between two slidably-engaged components. In the illustrated arrangement, the seal elements 134, 136 are O-rings.

The second seal arrangement 132 also includes an inner seal member 140 and an outer seal member 142. The inner seal member 140 creates an at least substantially fluid-tight seal between the negative spring piston 122 and a damper tube 150 of the damper 102, which is described in greater detail below. The outer seal element 142 creates an at least substantially fluid-tight seal between the negative spring piston 122 and the inner surface of the upper fork leg 80. When the first seal arrangement 130 is not in sealing contact with the flange 138, the negative spring is defined by both the first chamber section 112a and a second chamber section 112b (FIG. 12b), which generally is defined between the first seal arrangement 130 and the second seal arrangement 132. As will be appreciated, one or more generally radial ports 144 may be provided in the negative spring piston 122 to permit fluid communication between the sections 112a and 112b. Furthermore, other suitable arrangements for permitting the interconnection of the sections 112a and 112b may be used. The second chamber section 112b is also referred to herein as the second chamber 112b of the negative spring. The seal members 140, 142 may be any suitable construction that permits a seal to be created and maintained while also permitting sliding motion between two components. In the illustrated arrangement, the seal members 140, 142 are O-rings.

With reference to FIGS. 12a and 12b, the negative spring is illustrated in two positions of the suspension fork 50. In FIG. 12a, the seal arrangement 130, or upper seal, creates a seal with the downwardly extending flange 138 of the positive air spring piston 116. As a result, the negative air spring chamber 112 is defined between the seal member 118 and the seal arrangement 130. In other words, in the illustrated position, the negative air spring chamber 112 is substantially equivalent to the section 112a.

With reference to FIG. 12b, the upper fork leg 80 is moved downward within the lower fork leg 82 relative to the position shown in FIG. 12a such that the seal arrangement 130 no longer creates a seal with the downwardly extending flange 138 of the main piston 116. However, in the position of FIG. 12a, a seal is maintained between the lower seal arrangement 132 and the damper tube 150. As a result, in the illustrated position, the negative air spring chamber 112 is defined between the seal member 118 and the lower seal arrangement 132, or is substantially equivalent to the combination of sections 112a and 112b.

In operation, when seal created by the upper seal arrangement 130 and the downwardly-extending flange 138 is broken, the volume of the negative spring air chamber 112 immediately increases because a chamber defined between the upper seal arrangement 130 and the lower seal arrangement 132 is able to communicate with the chamber defined between the seal member 118 and the upper seal arrangement 130, such as through optional ports 144. The increase in volume in the illustrated arrangement is substantially equal to a volume of the generally annular chamber defined between the inner fork leg 80, the damper tube 150 and the upper and lower seal arrangements 130, 132 less the volume occupied by the negative spring piston 122 within the annular volume. In some arrangements, the volume of the negative spring air chamber 112 approximately doubles when the upper seal arrangement 130 disengages the flange 138. This immediate, relatively significant increase in volume of the negative spring air chamber 112 significantly reduces the force generated by the negative spring. As a result, the counteracting effect of the negative spring on the positive spring is substantially reduced. Such an arrangement permits the negative spring to produce a relatively significant counteracting force on the positive spring during initial compression, i.e., when the seal arrangement 130 engages the flange 138, to assist in initial compression movement of the suspension fork 50. Once the seal 130 disengages with the flange 138, the increase in volume of the negative spring air chamber 112 reduces the effect of the negative spring.

In contrast, during rebound motion of the fork 50, the volume of the negative spring air chamber 112 suddenly decreases when the seal arrangement 130 engages the flange 138. The sudden decrease in the volume of the negative spring air chamber 112 results in an increase in the spring rate of the negative spring air chamber 112, which provides greater resistance to further rebound movement and functions as a top-out spring to prevent mechanical contact between upper and lower portions of the fork 50. An equilibrium position, or relaxed position, of the fork 50 is a position in which the force developed by the negative spring air chamber 112 is equal to the force developed by the positive spring air chamber 110. Accordingly, the position of the seal arrangement 130 relative to the main piston seal member 118 determines at what position the forces of the negative spring air chamber 112 and the positive spring air chamber 110 balance and, thus, determines the length of the fork 50 in the relaxed position. Accordingly, altering the position of the seal arrangement 130, as described herein, may be utilized to alter the relaxed position of the fork 50.

In an alternative arrangement, instead of providing both an upper seal arrangement 130 and a lower seal arrangement 132, a single seal may an end of the negative spring and the negative spring may connect a main negative spring chamber with an auxiliary negative spring chamber when the seal passes over an opening to the auxiliary negative spring chamber. Although the illustrated negative spring arrangement is preferred, other suitable negative spring arrangements may also be used. For example, the negative spring may be a single stage gas spring, or coil spring, or may be another embodiment of a dual stage negative spring, such as a pair of coil springs, for example.

### Preferred Embodiments of a Damper

As described above, the suspension fork 50 also includes a damper 102. With reference to FIGS. 3 and 4, the damper 102 includes a piston rod 152 that is moveable with one of the upper and lower fork legs 80, 82. In the illustrated arrangement, the piston rod 152 is moveable with the upper fork leg 80. In particular, the piston rod 150 is connected to an upper end of the upper fork leg 80 through the top cap assembly 114. A piston 154 is carried on the lower end of the piston rod 152. The piston 154 is in sliding engagement with an inner surface of the damper tube 150. The piston 154 divides a damping chamber within an interior of the damper tube 150 into a compression chamber 156 below the piston 154 and a rebound chamber 158 above the piston 154.

The damper 102 also includes a reservoir tube 160 that is coupled to a lower end of the damper tube 150. The reservoir tube 160 defines a reservoir chamber 162 that is capable of receiving fluid displaced from the damper tube 150 during compression of the suspension fork 50 and permit fluid to return to the damper tube 150 upon rebound movement of the suspension fork 50. In the illustrated arrangement, the reservoir tube 160 is coaxial with the damper tube 150. In addition, the reservoir tube is axially off-set from the damper tube 150. That is, the reservoir tube 160 is positioned below the damper tube 150 and, preferably, the tubes 150 and 160 do not overlap along an axis of the fork leg 52. In the illustrated arrangement, the piston rod 152, damper tube 150 and reservoir tube 160 are removable from the fork leg 52 as a unit, or damper cartridge. Preferably, the damper cartridge contains all of the damping fluid used by the damper 102 such that no damper fluid remains within the fork leg 52 when the cartridge is removed. Some fluid used for lubrication purposes may remain in the fork leg 52, however.

Preferably, the reservoir tube 160 also accommodates an acceleration sensitive or acceleration actuated valve, or inertia valve 164. The inertia valve 164 is configured to distinguish between terrain-induced forces, tending to move the lower fork legs 82, 86 in an upward direction, from rider-induced forces, which tend to move the upper fork legs 80, 84 in a downward direction. The inertia valve 164 remains closed in response to rider-induced forces, but opens in response to a sufficient terrain-induced force to lower the damping force produced by the damper 102. Preferably, the damper 102 also includes a gas chamber 166 that is separated from the reservoir chamber 162 by a suitable partition, such as a floating piston 168. The floating piston 168 is moveable within the damper tube 160 to permit a volume of the reservoir chamber 162 to vary.

The piston rod 152 passes through an opening of the positive air spring piston 116 of the air spring 100. Thus, the positive air spring piston 116 also functions as a closure for the upper end of the damper tube 150. A seal member, such an O-ring 170, creates a substantially fluid tight seal between the positive air spring piston 116 and the piston rod 152 such that fluid is retained within the interior of the damper tube 150. As noted above, the piston 154 is carried by a lower end of the piston rod 152 and is positioned within the interior of the damper tube 150 throughout the suspension movement of the suspension fork 50. Thus, the piston rod 152 does not extend into the reservoir tube 160 at any point during the suspension movement of the suspension fork 50.

A top out bumper, or top out spring 172, is positioned above the piston 154 on the piston rod 152 to prevent direct contact between the piston 154 and the air spring piston 116 upon full extension of the suspension fork 150. The illustrated top out spring 172 includes a spring element 174, which in the illustrated arrangement is a molded rubber piece of material. An outer surface of the spring element 174 has an accordion-like shape to facilitate compression of the element 174. The spring element 174 also includes projections 176 on its lower end, which contact a retainer 178 that is fixed to the piston rod 152. The retainer 178 prevents the spring element 174 from moving downward on the piston rod 152 beyond the retainer 178. The projections 176 space the spring element 174 away from the retainer 178 and reduces the contact surface area between the spring element 174 and the retainer 178.

In the illustrated arrangement, the damping piston 154 permits fluid to move through the piston between the compression chamber 156 and the rebound chamber 158. However, in other arrangements, the piston 154 may be configured to prevent the fluid therethrough. Instead, the piston 154 may be configured to displace all of the fluid from the compression chamber 156 into the reservoir chamber 162.

The illustrated piston 154 includes one or more compression ports 180 that extend axially through the piston 154. Upper ends of the compression ports 180 are covered by a shim 182 that is lightly biased by a spring 184. The spring 184 normally maintains the shim 182 in contact with an upper surface of the piston 154 to prevent fluid flow through the compression ports 180 in a direction from the rebound chamber 158 toward the compression chamber 156. However, the biasing force of the spring 184 may be overcome in response to compression fluid flow from the compression chamber 156 to the rebound chamber 158 such that the shim 182 moves away from the piston 154 to permit fluid flow in the compression direction.

Preferably, the piston 154 also includes a plurality of rebound ports 186. Lower ends of the rebound ports 186 are covered by one or more shims 188 that function as a one-way valve. The shims 188 permit fluid flow in a rebound direction from the rebound chamber 158 into the compression chamber 156 through the rebound port 186 against the biasing force of the shims 188. However, the shims 188 remain closed to prevent fluid flow through the rebound port 186 in a direction from the compression chamber 156 to the rebound chamber 158.

The piston 154 also includes a two-way valve. A lower end of the piston rod 154 defines an opening 190 that communicates with the compression chamber 156. The opening 190 opens into a passage 192 within the piston rod 152 that extends through the piston 154. One or more ports 194 permit fluid communication between the rebound chamber 158 and the passage 192. Thus, fluid flow may be permitted between the compression chamber 156 and the rebound chamber 158 through the passage 192 in both compression and rebound direction of movement of the fork 50. A needle and orifice valve is positioned within the passage 192 between the opening 190 and the ports 194 and includes a needle portion 196 having a tapered end that corresponds with an orifice 198 within the passage 192. An adjustment rod 200 extends through the piston rod 152 and carries the needle portion 196. The adjustment rod 200 permits an axial position of the needle portion 196 to be adjusted relative to the orifice 198. Thus, the needle portion 196 may be adjusted to permit a desired level of fluid flow through the passage 192.

With reference to FIG. 5, the top cap assembly 114 includes an adjuster knob 202 that is coupled to the needle adjustment rod 200 through a motion transfer mechanism 204. The mechanism 204 is configured to translate rotational motion of the adjuster knob 202 into axial movement of the needle adjustment rod 200, and thus the needle 196. The mechanism 204 may be of any suitable construction to cause axial movement of the needle adjustment rod 200 in response to rotation of the adjuster knob 202. In the illustrated arrangement, the mechanism has a first portion or shaft 206 that is fixed for rotation with the adjuster knob 202. The mechanism also has a second portion or connector 208 that is fixed for rotation with the needle adjustment rod 200. The shaft 206 and the connector 208 are rotatably coupled, but are capable of sliding relative to one another. In one arrangement, the shaft 206 and connector 208 engage one another through complementary, non-circular cooperating portions that fix the shaft 206 and connector 208 for rotation, but permit sliding motion therebetween. A third portion or sleeve 210 is supported by the top cap assembly 114. Incidentally, in the illustrated arrangement, the sleeve 210 couples the piston rod 152 to the top cap assembly 114. The connector 208 is coupled to the sleeve 210 by a threaded connection 211 such that rotation of the connector 208 results axial movement or translation of the connector 208 relative to the sleeve 210. The shaft 206 thus causes rotation of the connector 208. Rotation of the connector 208 causes axial movement or translation of the connector 208 relative to the sleeve 210, which moves the needle adjustment rod 200 to adjust the needle 196.

The top cap assembly 114 also includes an air valve 212 that permits communication with the positive air spring chamber 110. The air valve 212 is integrated with the adjustment mechanism 204 and, more particularly, is positioned with a cavity of the shaft 206. Preferably, a cap 214 is provided to cover the valve 212. In the illustrated arrangement, the cap 214 snaps onto the adjuster knob 202.

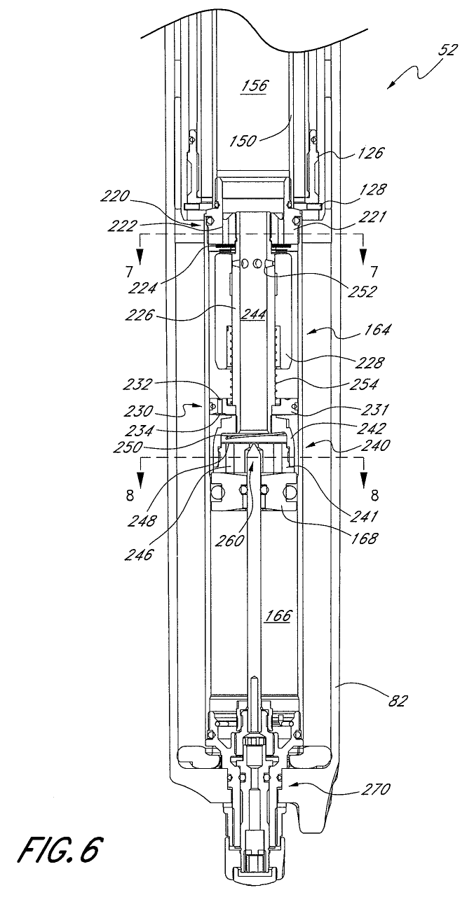

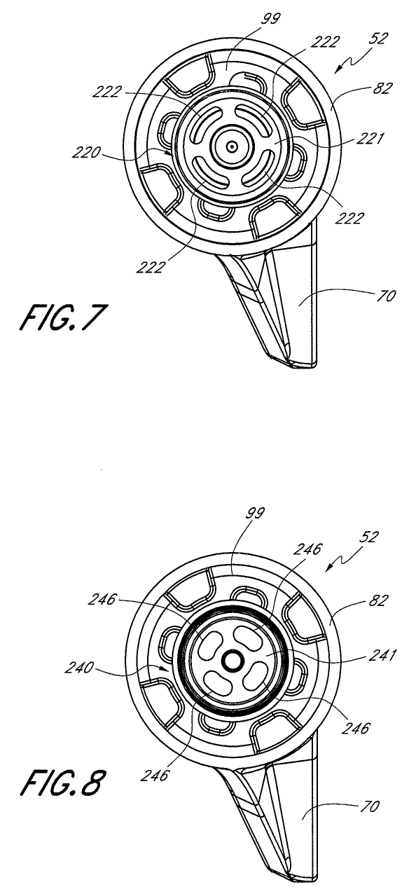

With reference to FIG. 6, preferably, multiple valves control fluid flow between the compression chamber 156 and the reservoir chamber 162. Preferably, a base valve 220 permits compression flow from the compression chamber 156 to the reservoir chamber 162 through a one-way check valve mechanism including one or more compression ports 222. As shown in FIG. 7, multiple arcuate-shaped ports 222 are provided in the base valve 220. The ports 222 occupy a substantial portion of the cross-sectional area of the piston 221 to permit a substantial amount of fluid flow through the ports 222 of the base valve 220. In the illustrated arrangement, four ports 222 are provided. One or more shims 224 cover lower ends of the compression ports 222 to permit fluid flow in the compression direction through the ports 222 while preventing fluid flow in the rebound direction. A body 221 of the base valve 220 is annular in shape and couples the reservoir tube 160 and the damper tube 150, with the damper tube 150 positioned above the reservoir tube 160. The body 221 of the base valve also supports an upper end of a shaft 226 upon which an inertia mass 228 of the inertia valve 164 slides.

A lower end of the shaft 226 is supported relative to the reservoir tube 160 by a compression valve assembly 230. The compression valve assembly 230 includes a valve body or piston 231 that is annular in shape and occupies a space between the shaft 226 and the reservoir tube 160. The compression valve 230 permits fluid flow in a compression direction from a portion of the reservoir chamber 162 above the piston 231 to a portion of the reservoir chamber 162 below the piston 231. The piston 231 defines one or more compression ports 232 that pass axially through the piston 231. A lower end of the compression ports 232 are normally closed by a shim 234 that may open in response to compression fluid flow through the port 232 but at least substantially prevents rebound flow through the port 232.

A rebound valve 240 is supported on a lower end of the shaft 226 and, preferably, includes a one-way valve arrangement that permits rebound fluid flow from the reservoir chamber 162 to the compression chamber 156, but at least substantially prevents compression fluid flow from the compression chamber 156 to the reservoir chamber 162. The rebound valve 240 includes a piston 241 supported within a cup 242. An interior space of the cup communicates with a passage 244 of the shaft 226. The piston 241 includes at least one, and preferably a plurality of rebound ports 246, and upper end of which are normally closed by a check plate 248. The check plate 248 is normally biased against an upper surface of the piston 241 by a biasing spring 250 and is configured to open in response to rebound fluid flow through the ports 246. However, the check plate 248 remains in contact with the upper surface of the piston 241 in response to compression flow to at least substantially prevent compression flow through the ports 246. With reference to FIG. 8, preferably four rebound ports 246 are provided in the piston 241. The rebound ports 246 desirably are somewhat arcuate in shape and occupy a substantial portion of the cross-sectional area of the piston 241 to permit a significant amount of fluid flow through the ports 246.

As described above, the damper 102 preferably also includes the inertia valve 164. The inertia valve 164 includes the inertia mass 228 that slides on the shaft 226 to selectively uncover one or more ports 252. The ports 252 extend in a radial direction through the shaft 226 to permit fluid communication between the passage 244 and the reservoir chamber 162. In one arrangement, a groove (not shown) may be formed in an outer surface of the shaft 226 and extend circumferentially around the shaft 226 to interconnect the ports 252. Thus, the groove can function as a manifold to combine fluid from the individual ports 252 and equalize the pressure of the fluid exiting the ports 252.

The inertia mass 228 is normally biased in an upward direction to a position at least partially, and preferably completely, covering the ports 252 by a biasing element, such as a spring 254. A position in which the inertia mass 228 is partially or completely covering the ports 252 may be referred to as a closed position of the inertia mass 228. As will be appreciated by one of skill in the art, even if the inertia mass 228 is in a position completely covering the ports 252, some amount of fluid flow through the ports 252 may still be permitted because the inertia mass 228 typically does not establish a fluid-tight seal with the shaft 226. Fluid flow through the ports 252 when the inertia mass is covering the ports 252 is often referred to as “bleed” flow.

In response to a sufficient terrain-induced force that moves the lower fork leg 82 (and reservoir tube 160 and shaft 226) in an upward direction, the inertia mass 228 remains generally stationary. In other words, the inertia mass 228 moves downward relative to the shaft 226, compressing the spring 254 and opening the ports 252 to permit fluid flow through the ports 252 from the compression chamber 156 to the rebound chamber 162.

Preferably, the damper 102 also includes a two-way valve 260 that permits fluid flow in both the compression and rebound directions between the compression chamber 156 and the reservoir chamber 162. The illustrated two-way valve 260 is a needle-and-orifice-type valve similar to the needle 196 and orifice 198 described above with reference to FIG. 4. Desirably, the valve 260 is adjustable by an adjustment mechanism 270 that is similar to the adjustment mechanism 204 described above with reference to FIG. 5. That is, the adjustment mechanism 270 permits an axial position of the needle to be altered relative to the orifice.

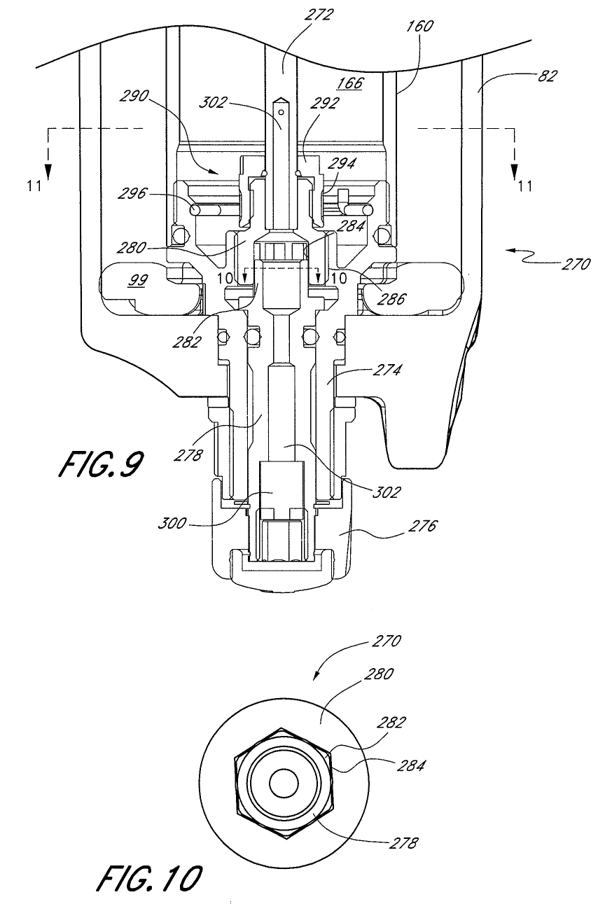

With reference to FIGS. 9 and 10, a preferred arrangement of the adjustment mechanism 270 is illustrated. The needle portion of the needle and orifice valve 260 is carried by a needle adjustment rod 272. The needle adjustment rod 272 extends from the adjustment mechanism 272, through the gas chamber 166, to the needle and orifice valve 260. An axially elongated sleeve 274 couples the reservoir tube 160 to a lower end of the lower fork leg 82. An adjustment knob 276 is fixed to an adjustment shaft 278 such that rotation of the knob 275 causes rotation of the shaft 278. The shaft 278 passes through a passage defined by the elongate sleeve 274 and is rotatable relative to the sleeve 274. A connector 280 couples the adjustment rod 272 with the adjustment shaft 278. In particular, a non-circular projection 282 of the adjuster shaft 278 engages a correspondingly shaped non-circular recess 284 of the connector 280. With reference to FIG. 10, in the illustrated arrangement both the projection 282 and the recess 284 are of a corresponding hexagonal cross-sectional shape. However, other suitable non-circular cross-sectional shapes may also be used. The corresponding non-circular cross-sectional shapes fix the adjustment shaft 278 for rotation with the connector 280 while allowing relative axial movement, or translation, therebetween. In addition, the connector is coupled to the sleeve 274 by a threaded connection 286. As a result, when the adjustment shaft 278 is rotated via the adjustment knob 276, the connector 280 is also rotated. Rotation of the connector 280 results in axial movement, or translation, of the connector 280 as a result of the threaded connection 286. The adjustment rod 272 is carried by the connector 280 and, thus, axial movement of the connector 280 causes axial movement of the adjuster rod 272 to adjust the axial position of the needle and orifice valve 260.

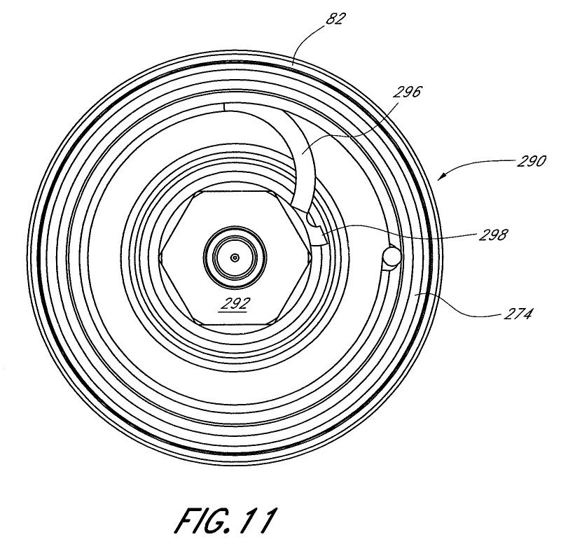

With additional reference to FIG. 11, preferably, the adjustment mechanism 270 also includes a detent mechanism 290 that provides a user with tactile feedback in adjustment of the needle orifice valve 260. The detent mechanism 290 permits the needle and orifice valve 260 to be set in one of a finite number of available positions. The illustrated detent mechanism 290 includes a detent member 292 that is rotatable with the connector 280. An outward-facing surface of the detent member 292 defines a plurality of elongate recesses or detents 294. The detents 294 extend in an axial direction. A generally annular spring member 296 is secured to the sleeve 274 and includes a curved end portion 298 that engages one of the detents 294 of the detent member 292 at any given time. Because the detent member 292 moves in an axial direction along with the adjustment rod 272 and connector 280 upon adjustment of the needle and orifice valve 260, the recesses 294 are elongated such that the end 298 of the spring 296 is capable of engaging a recess 294 throughout range of axial movement of the detent member 292. Such a detent arrangement 290 is preferred because of its simplicity and reliability. In addition, the illustrated detent arrangement 290 reduces costs by reduces the number of parts required in comparison to prior art detent arrangements and easing assembly.

With reference to FIGS. 6 and 9, preferably the suspension fork 50 also includes a fill valve 300 that permits a suitable gas (e.g., nitrogen) to be introduced into the gas chamber 166. As discussed above, the valve adjustment rod 272 extends through the gas chamber 166 and passes through a central opening of the floating piston 168. Thus, the floating piston 168 is in sealed, sliding engagement with the valve adjustment rod 272. A passage 302 defined by the shaft 278, connector 280 and the valve adjustment rod 272 permits gas to be introduced to the gas chamber 166 via the valve 300. Thus, at least a portion of the components of the damping valve adjustment mechanism 270 support the valve 300 and define the passage 302. Thus, the valve 300 and passage 302 are integral with the valve adjustment mechanism 270.

### Operation of the Suspension Assembly

The operation of the present suspension fork 50 will be apparent to one of skill in the art based on the foregoing disclosure of the structure, assembly and operation of the various components and sub-assemblies of the suspension fork 50. However, a brief description of the operation of the suspension fork 50 in response to terrain-induced forces and rider-induced forces is provided below.

In operation, when the mountain bike 20 encounters a bump, a terrain-induced force may be transmitted to the lower legs 82, 86 of the suspension fork 50 through the front wheel 24. In response to the terrain-induced force, the lower fork legs 82, 86 tend to move upward relative to the upper fork legs 80, 84 and, thus, compress the suspension fork 50. Air pressure within the positive suspension spring chamber 110 produces a force tending to resist the compression motion of the suspension fork 50. As described above, air pressure within the negative spring chamber 112 produces a force tending to assist the initial compression of the suspension fork 50. The force of the negative spring is substantially reduced once the upper seal 130 disengages from the downward extending flange 138 of the main air spring piston 116. Further, the counteracting force of the negative spring is further reduced as the volume of the negative spring chamber 112 increases due to relative movement between the upper fork leg 80 and lower fork leg 82 and, thus, movement of the negative spring piston 122 away from the main piston 116. Thus, the negative spring chamber 112 assists initial compression movement of the suspension fork 50, but preferably does provide a significant affect on the overall behavior of the suspension spring 100 throughout the remainder of the suspension travel of the fork 50 such that the characteristics of the suspension spring 100 are determined primarily by the positive spring chamber 110.

The damper 102 also provides a resistive force to compression of the suspension fork 50. As described above, the piston 154 moves downward within the damper tube 150 along with downward movement of the upper fork leg 80 relative to the lower fork leg 82. As a result, the volume of the compression chamber 156 is reduced. Conversely, the volume of the rebound chamber 158 is increased. However, because a greater volume of the piston rod 152 occupies the space within the damper tube 150 above the piston 154 as the piston moves downward, the increase in the volume of the rebound chamber 158 is less than the decrease in volume of the compression chamber 156. As a result, a portion of the fluid displaced from the compression chamber 156 moves to the reservoir chamber 162.

As described above, there are several damping circuits through which fluid displaced from the compression chamber 156 moves to the reservoir chamber 162. If the terrain-induced force is not sufficient to activate the inertia valve 164, fluid from the compression chamber 156 flows through the passage 244 of the shaft 226 and, assuming the needle and orifice valve 260 is at least partially open, flows through the needle and orifice valve 260 and into the reservoir chamber 162. The flow rate of fluid flow through the needle and orifice valve 260 is dependent upon the position of the needle relative to the orifice as adjusted by the adjustment mechanism 270.

Fluid can also be displaced from the compression chamber 156 to the reservoir chamber 162 during compression of the suspension fork 50 through the base valve 220, assuming a sufficient fluid pressure is reached in the compression chamber 156. Flow through the base valve 220 passes alongside the inertia mass 228 assisting in either initially opening the inertia mass 228 or maintaining the inertia mass 228 in an open position while compression flow occurs. Once past the inertia mass 228, the compression fluid flow moves through the compression valve 230 and into the portion of the reservoir chamber 162 below the piston 231. Preferably, the base valve 220 is more restrictive than either the compression valve circuit 180, 182 of the piston 154 or the compression valve 230 such that the compression damping force is primarily determined by the base valve 220 when the base valve 220 is open. However, as will be appreciated, it is possible to tune the various valves relative to one another to achieve desired damping characteristics through a range of compression velocities.

If the terrain-induced force is sufficient to activate the inertia valve 164, the inertia valve moves downward on the shaft 226 to permit fluid flow through the inertia valve 164 from the compression chamber 156 to the reservoir chamber 162. Preferably, when the inertia valve 164 is activated, the terrain-induced force is usually also sufficient to open the base valve 222. Thus, preferably the base valve 222 and the inertia valve 164 work in cooperation with one another when the inertia valve 164 is open.

After the bump is absorbed, the air pressure within the suspension spring 100 tends to extend the upper fork legs 80, 84 relative to the lower fork legs 82, 86 in what is referred to as rebound movement of the suspension fork 50. Within the damper tube 150 fluid flow occurs from the rebound chamber 158 through the rebound valve comprised of the rebound ports 186 and shim 188 of the damping piston 154. Due to the volume occupied by the piston rod 152, the fluid moving from the rebound chamber 158 to the compression chamber 156 is not sufficient to replace the fluid that was displaced from the compression chamber 156. Accordingly, fluid from the reservoir chamber 162 refills the remainder of the compression chamber 156. Rebound fluid flow from the reservoir chamber 162 to the compression chamber 156 is permitted through the needle and orifice valve 260, if open, and through the rebound valve 240, assuming a sufficient fluid pressure is present within the reservoir chamber 162. Preferably, the rebound valve 186, 188 of the piston 154 is more restrictive than the rebound valve 246. In addition, rebound fluid flow through the needle and orifice valve 260 is minimal compared to rebound fluid flow through the piston 154 such that the rebound damping rate is primarily determined by the rebound flow through the piston 154. However, as with the compression valves, the various rebound valves may be tuned relative to another to achieve desired rebound damping characteristics throughout a range of rebound velocities.

In response solely to rider-induced forces, which are forces tending to move the upper fork legs 80, 84 in a downward direction relative to the lower fork legs 82, 86, the inertia valve 164 normally will not be activated. Although the inertia valve circuit 164 does not activate in response to rider induced forces, compression fluid flow is still permitted through the needle and orifice valve 260 so that the suspension fork 50 can compress to some degree. If the rider induced force is sufficient, the base valve 220 may open to permit additional fluid flow from the compression chamber 156 to the reservoir chamber 162. In addition, the positive suspension spring chamber 110 tends to resist compression movement of the fork 50, while the negative spring chamber 112 tends to assist initial compression movement of the fork 50 in response to rider-induced forces in a similar manner to terrain-induced forces.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In particular, while the present bicycle suspension assembly has been described in the context of particularly preferred embodiments, the skilled artisan will appreciate, in view of the present disclosure, that certain advantages, features and aspects of the suspension assembly may be realized in a variety of other applications, many of which have been noted above. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiments described above, but should be determined only by a fair reading of the claims.

What is claimed is:

1. A bicycle suspension fork, comprising:
a first fork leg comprising an upper fork tube and a lower fork tube;
a second fork leg comprising an upper fork tube and a lower fork tube;
a suspension spring that provides substantially all of a spring force of said suspension fork, said suspension spring positioned within said first fork leg and not within said second fork leg, said suspension spring comprising a gas spring chamber and a gas spring piston, wherein said gas spring piston is movable to vary a volume of the gas spring chamber;
a damper that provides substantially all of a damping force of said suspension fork, said damper positioned within said first fork leg and not within said second fork leg, said damper comprising a damping chamber, a piston rod and a damping piston supported on an end portion of the piston rod, wherein said piston rod and said damping piston are movable within said damping chamber;
wherein said damping piston moves relative to said gas spring piston when said upper fork tube of said first fork leg moves relative to said lower fork tube of said first fork leg.

2. The bicycle suspension fork of claim 1, wherein said piston rod and said damping piston are movable with said upper fork tube of said first fork leg and said gas spring piston is movable with said lower fork tube of said first fork leg.

3. The bicycle suspension fork of claim 1, wherein said piston rod extends entirely through said gas spring chamber.

4. The bicycle suspension fork of claim 1, further comprising a reservoir chamber that receives fluid displaced from said damping chamber, and a floating piston that separates said reservoir chamber from a gas chamber of said damper.

5. The bicycle suspension fork of claim 1, wherein said gas spring chamber is a positive spring that produces a force tending to extend said upper fork tube and said lower fork tube of said first fork leg, said suspension fork further comprising a negative gas spring chamber that produces a force tending to compress said upper fork tube and said lower fork tube of said first fork leg, wherein said negative gas spring chamber at least partially surrounds said damping chamber.

6. The bicycle suspension fork of claim 1, wherein said damper further comprises a damper tube at least partially defining said damping chamber.

7. A bicycle suspension fork, comprising:
a first fork leg comprising a first fork tube telescopically engaged with a second fork tube;
a second fork leg comprising a first fork tube telescopically engaged with a second fork tube;
a suspension spring that provides substantially all of a spring force of said suspension fork, said suspension spring positioned within said first fork leg and not within said second fork leg, said suspension spring comprising a gas spring chamber and a gas spring piston, wherein said gas spring piston is movable to vary a volume of the gas spring chamber;
a damper that provides substantially all of a damping force of said suspension fork, said damper positioned within said first fork leg and not within said second fork leg, said damper comprising a damping chamber, a piston rod and a damping piston supported on an end portion of the piston rod, wherein said piston rod and said damping piston are movable within said damping chamber;
wherein said damping piston is coupled for movement with said first fork tube of said first fork leg and said gas spring piston is coupled for movement with said second fork tube of said first fork leg.

8. The bicycle suspension fork of claim 7, wherein said piston rod extends entirely through said gas spring chamber.

9. The bicycle suspension fork of claim 7, further comprising a reservoir chamber that receives fluid displaced from said damping chamber, and a floating piston that separates said reservoir chamber from a gas chamber of said damper.

10. The bicycle suspension fork of claim 7, wherein said gas spring chamber is a positive spring that produces a force tending to extend said first fork tube and said second fork tube of said first fork leg, said suspension fork further comprising a negative gas spring chamber that produces a force tending to compress said first fork tube and said second fork tube of said first fork leg, wherein said negative gas spring chamber at least partially surrounds said damping chamber.

11. The bicycle suspension fork of claim 7, wherein said damper further comprises a damper tube at least partially defining said damping chamber.

12. A bicycle suspension fork, comprising:
a first fork leg comprising an upper fork tube and a lower fork tube;
a second fork leg comprising an upper fork tube and a lower fork tube;
a suspension spring that provides substantially all of a spring force of said suspension fork, said suspension spring positioned within said first fork leg and not within said second fork leg, said suspension spring comprising a gas spring chamber and a gas spring piston, wherein said gas spring piston is movable to vary a volume of the gas spring chamber;
a damper that provides substantially all of a damping force of said suspension fork, said damper positioned within said first fork leg and not within said second fork leg, said damper comprising a damping chamber, a piston rod and a damping piston supported on an end portion of the piston rod, wherein said piston rod and said damping piston are movable within said damping chamber, a reservoir chamber that receives fluid displaced from said damping chamber, wherein said damping chamber is separated from said reservoir chamber by one or more valves.

13. The bicycle suspension fork of claim 12, wherein said piston rod does not pass through said reservoir chamber.

14. The bicycle suspension fork of claim 12, further comprising a damper tube that at least partially defines said damping chamber and a reservoir tube that at least partially defines said reservoir chamber.

15. The bicycle suspension fork of claim 14, wherein said damper tube is coaxial with said reservoir tube.

16. The bicycle suspension fork of claim 14, wherein said damper tube is axially offset from said reservoir tube.

17. The bicycle suspension fork of claim 12, wherein said one or more valves comprises at least one pressure-activated valve and at least one acceleration-activated valve.

18. The bicycle suspension fork of claim 17, wherein said at least one pressure-activated valve comprises a first valve that permits fluid flow in a direction from the damping chamber to the reservoir chamber and a second valve the permits fluid flow in a direction from the reservoir chamber to the damping chamber, wherein said second valve is separate from said first valve.

19. The bicycle suspension fork of claim 18, wherein said acceleration-activated valve comprises an inertia mass supported on a shaft, wherein said fluid flow through said first valve is directed around said shaft and along a side of said inertia mass and fluid flow through said second valve is directed through said shaft.

20. The bicycle suspension fork of claim 12, wherein said one or more valves comprises at least one pressure-activated valve that permits fluid flow in a direction from said damping chamber to said reservoir chamber.

21. The bicycle suspension fork of claim 20, wherein said damping piston divides said damping chamber into a compression chamber and a rebound chamber, further comprising a pressure-activated compression valve associated with said damping piston that permits fluid flow from said compression chamber to said rebound chamber, wherein said at least one pressure-activated valve is more restrictive than said compression valve of said damping piston.

22. The bicycle suspension fork of claim 12, further comprising a floating piston that separates said reservoir chamber from a gas chamber of said damper.

23. The bicycle suspension fork of claim 12, wherein said gas spring chamber is a positive spring that produces a force tending to extend said upper fork tube and said lower fork tube of said first fork leg, said suspension fork further comprising a negative gas spring chamber that produces a force tending to compress said upper fork tube and said lower fork tube of said first fork leg, wherein said negative gas spring chamber at least partially surrounds said damping chamber.

24. A suspension assembly for a bicycle, comprising:
a first portion;
a second portion;
a first piston carried by said second portion, said first piston and said first portion cooperating to define a positive air spring chamber that produces a force tending to extend said first portion relative to said second portion;
a negative air spring that produces a force tending to compress said first portion and said second portion, said negative air spring comprising a first chamber and a second chamber;
at least a first seal arrangement, wherein said first seal arrangement separates said first chamber from said second chamber in a first relative position of said first portion and said second portion and wherein said first seal arrangement allows communication between said first chamber and said second chamber in a second relative position of said first portion and said second portion.

25. The suspension assembly of claim 24, wherein a first end of said negative air spring is defined by said first piston.

26. The suspension assembly of claim 24, wherein said first piston comprises a longitudinally-extending flange, said first seal arrangement is configured to create a seal with said longitudinally-extending flange in said first relative position.

27. The suspension assembly of claim 24, further comprising a damper having a damping chamber, a piston rod and a damping piston carried by said piston rod, said damping piston is movable within said damping chamber, wherein at least one of said first and second chambers of said negative air spring at least partially surround said damping chamber.

28. The suspension assembly of claim 24, wherein a first end of said first chamber defines a first end of said negative air spring, wherein a second end of said negative air spring is defined by said first seal arrangement in said first relative position of said first portion and said second portion, further comprising a second seal arrangement, wherein said second end of said negative air spring is defined by said second seal arrangement in said second relative position of said first portion and said second portion.

29. The suspension assembly of claim 28, wherein said first seal arrangement defines a first diameter and said second seal arrangement defines a second diameter that is different than said first diameter.

30. The suspension assembly of claim 28, wherein said second seal arrangement is configured to create a seal with a component of said second portion other than said first piston.

31. The suspension assembly of claim 30, wherein said second seal arrangement maintains said seal in both said first relative position and said second relative position of said first portion and said second portion.

32. The suspension assembly of claim 24, wherein a volume of the negative air spring is adjustable.

33. The suspension assembly of claim 32, wherein said first seal arrangement is movable with a negative air spring piston, said negative air spring piston is movable with said first portion, and a position of said negative air spring piston is adjustable relative to said first portion.

34. The suspension assembly of claim 33, wherein said negative air spring piston is coupled to said first portion by a support tube.

35. The suspension assembly of claim 34, wherein said negative air spring piston is coupled to said support tube by a threaded connection that permits an axial position of said negative air spring relative to said support tube to be adjusted.

36. A method of adjusting a mass of fluid within a suspension assembly, comprising:
providing a tube that forms a portion of the suspension assembly;
inserting a first piston into an open end of a tube to create a seal between the first piston and the tube and to define a first end of a fluid chamber;
advancing the first piston within the tube until the first end of the fluid chamber is in a first position relative to the open end of the tube;
allowing a fluid to enter the fluid chamber; and
inserting a second piston into the tube to create a seal between the second piston and the tube and to define a second end of the fluid chamber;
wherein the first position of the first piston is selected such that the insertion of the second piston traps a desired mass of the fluid within the fluid chamber.

37. A bicycle suspension fork, comprising:
a first fork leg comprising an upper fork tube and a lower fork tube;
a second fork leg comprising an upper fork tube and a lower fork tube;
a suspension spring that provides substantially all of a spring force of said suspension fork, said suspension spring positioned within said first fork leg and not within said second fork leg;
a damper that provides substantially all of a damping force of said suspension fork, said damper positioned within said first fork leg and not within said second fork leg;
a crown that couples said upper fork tube of said first fork leg with said upper fork tube of said second fork leg, wherein said crown comprises a wall portion that extends completely over an upper end of said upper fork tube of said second fork leg.

38. The bicycle suspension fork of claim 37, wherein said wall portion of said crown closes an opening of said upper end of said upper fork tube of said second fork leg.

39. The bicycle suspension fork of claim 38, wherein a lower end of said lower fork tube of said second fork leg defines an access opening that permits a lubricating fluid to be introduced into an interior space of said second fork leg.
